(19) United States
(12) Patent Application Publication
(10) Pub. No.: US 2010/0181957 A1
(43) Pub. Date: Jul. 22, 2010

(54) Solar powered, grid independent EV charging system

(76) Inventor: Christoph Goeltner, Cupertino, CA (US)

Correspondence Address: WOODSIDE IP GROUP, P.O. BOX 61047, PALO ALTO, CA, 94306, US

(21) Appl. No.: 12/586,255

(22) Filed: Sep. 18, 2009

Related U.S. Application Data
(60) Provisional application No. 61/192,790, filed on Sep. 19, 2008.

(51) Int. Cl. H01M 10/46

(52) U.S. Cl. 320/101; 180/65.29

(57) ABSTRACT

A system for charging a multiplicity of commuter EVs without dependence on the power grid is provided, using the EV batteries themselves as distributed off grid storage for all EVs connected to the system. The EV charging system comprises low cost solar modules and an intelligent charge management system capable of a providing flexible charge rate to EVs based on user demand, that is decoupled from the grid and thus does not add to peak power demands. Only a low capacity grid connection is provided for backup, and buffer solar panels may be provided for load balancing. Excessive solar energy is fed into the grid during times of low demand at the charging stations, such as on weekends.

### CROSS REFERENCE TO RELATED APPLICATION

This application claims the benefit of U.S. provisional patent application Ser. No. 61/192,790, filed Sep. 19, 2008.

### BACKGROUND

1. Field of the Invention

The field of the invention relates generally to a charging system for electric/hybrid vehicles (EVs). In particular, the field of the invention relates to an economically viable system and method for charging a multiplicity of commuter EVs without dependence on the power grid, using the EV batteries themselves as distributed off grid storage, and adaptive feedback control to individualize the charge to EVs connected to the system in accordance with customer requirements and battery demand.

2. Background of Related Art

Commuters are adopting battery electric powered vehicles (BEVs) or plug in hybrid electric vehicles (PHEVs) in increasingly large numbers due to the escalating cost of gasoline. All such EVs employ rechargeable, high-capacity batteries that must be connected to an external power source (the power grid) to enable battery recharging. Charging time may range from minutes to many hours depending upon the extent to which the batteries have been depleted.

When commuters reach work, it often is necessary to recharge the batteries in an EV due to their limited range. Such charging during the day coincides with peak power usage and severely impacts the power grid. The electric power demand for charging EVs adversely increases the cost per kilowatt-hour that a consumer must pay for electricity. Further, there is not enough surplus grid power to meet the increasing demand for charging EVs during peak grid usage periods.

The rapid charge of EV batteries with conventional grid-tied chargers results in a surge of power demand even when only a modest number of vehicles require a charge, such as at rush hour times, e.g. at 4:00 PM, before driving home. Based on present infrastructure limitations, a large population of EVs would be very difficult to routinely recharge without a massive increase of grid based power generation capacity. At present grid delivery rates, a very high peak load for a quick charge would be prohibitive for large number of EVs.

Although solar panels have started to appear in carport applications for charging EVs, their power output and the EV charging stations are completely decoupled. The entire load required by the EV batteries is presently channeled from solar panels through the AC grid. The rapid charge of EV batteries with conventional grid-tied chargers results in a surge of power demand even when only a modest number of vehicles require a charge at rush hour times, e.g. at 4:00 PM before commuters drive home. Based on these infrastructure limitations a large population of EVs is very difficult to routinely recharge without a massive increase of grid based power generation capacity.

Therefore, what is needed is a system and method for grid independent direct charging stations that charge EVs directly from a DC source, wherein the charging stations are capable of being completely grid-independent during peak demand times.

What is also needed are large scale distributed solar powered, grid independent, carports or parking structures that are provided with controllers capable of selectively trickle charging or fast charging the EV cars parked therein. Alternatively, large-scale solar arrays in the vicinity of grid independent charging stations (for underground garages) are also desirable.

It also would be desirable to provide low cost solar modules and an intelligent charge management system capable of implementing a flexible charge rate based on the user demand.

### SUMMARY

In order to overcome the foregoing limitations and disadvantages inherent in conventional grid coupled EV charging systems, an aspect of the invention provides grid-independent direct charging stations that comprise distributed solar powered carports capable of trickle charging the EV cars parked underneath. Alternatively, larger solar arrays can be provided in the vicinity of grid independent charging stations, such as for underground garages.

Another aspect of the invention comprises low cost solar modules and an intelligent charge management system capable of a providing flexible charge rate based on the user demand that is decoupled from the grid and thus does not add to peak power demands. Only a low capacity grid connection is provided for backup (e.g. bad weather), and buffer solar panels may be provided for load balancing. Excessive solar energy is fed into the grid during times of low demand at the charging stations (e.g. on weekends).

Another aspect of the invention provides a system for charging a multiplicity of commuter EVs without dependence on the power grid, using the EV batteries themselves as distributed off grid storage for all EVs connected to the system. Adaptive feedback control is used to individualize the charge to EVs connected to the system in accordance with customer requirements and battery demand.

One of the fundamental problems with solar PV power is its storage. In the current (2009) energy mix, with the PV contribution being 1% or even less, the storage issue is being circumvented by using the grid as a buffer. Once there is more PV power available, the storage issue needs to be addressed. An aspect of the invention resolves this problem without adding any additional storage medium, provided that there is a sufficient number of EVs available. Any access energy generated will be usefully fed back to the grid. At the same time EVs can be completely charged by a renewable energy source, thereby facilitating the full environmental benefit of EV technology.

### BRIEF DESCRIPTION OF THE DRAWINGS

The drawings are heuristic for clarity. The foregoing and other features, aspects and advantages of the invention will become better understood with regard to the following description, appended claims and accompanying drawings in which:

FIG. 1 is a schematic diagram showing a conventional grid coupled charging system for EVs.

FIG. 2 is a schematic diagram showing a DC charging system directly coupled to an EV independently from the grid in accordance with an aspect of the invention.

FIG. 3 is a schematic diagram showing an overview of a solar powered EV charging system in accordance with an aspect of the invention.

FIG. 4 is a schematic diagram showing variations of a solar powered EV charging system in accordance with an aspect of the invention.

FIG. 5 is a schematic diagram showing a solar powered EV charging system with DC power distribution in accordance with an aspect of the invention.

FIG. 6 is a is a schematic diagram showing a solar powered EV charging system with AC power distribution in accordance with an aspect of the invention.

FIG. 7 is a table showing a comparison of AC and DC power distribution for a charging system in accordance with an aspect of the invention.

FIG. 8 is a schematic diagram showing details of a central management unit for a DC implementation of a solar powered EV charging system in accordance with an aspect of the invention.

FIG. 9 is a schematic diagram showing details of a central management unit for an AC implementation of a solar powered EV charging system in accordance with an aspect of the invention.

FIG. 10 is a schematic diagram showing details of a DC client for a solar powered EV charging system in accordance with an aspect of the invention.

FIG. 11 is a schematic diagram showing details of an AC client for a solar powered EV charging system in accordance with an aspect of the invention.

### DETAILED DESCRIPTION

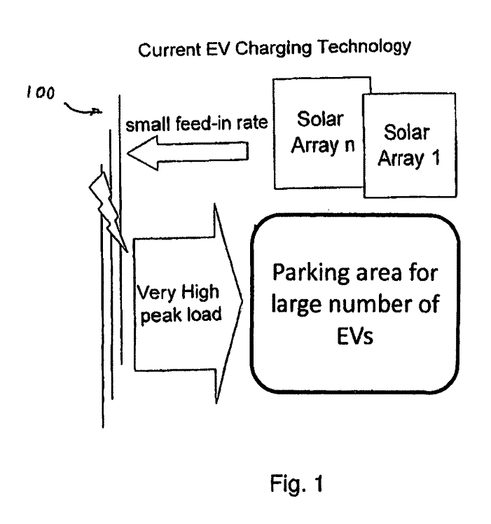

Referring to FIG. 1, in a conventional EV charging system, solar power and DC power for EV charging are decoupled. Solar power from a plurality of solar arrays, solar array 1 through solar array n, is connected to the grid 100 as shown, converted back to AC and electrically coupled to the grid with a typically small feed in rate as shown. The AC grid power then must be converted back to DC for charging the EV. This is done generally while commuters are at work, and results in a very high peak load needed for a quick charge of EV batteries. This load occurs during peak demand hours and thus will be prohibitive for a large number of EVs.

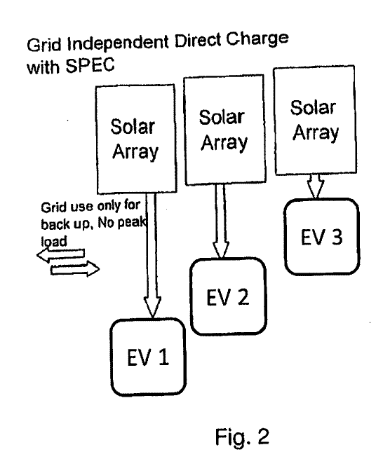

Referring to FIG. 2, in accordance with an aspect of the invention, a plurality of solar arrays are provided for charging EVs directly without conversion to AC, and without being coupled to the grid. Since grid decoupling is complete, the present system is independent of the peak demand hours for the grid, and is suitable for charging a large number of EVs.

A realistic commuter scenario demonstrating the effectiveness of a direct solar energy coupled DC charging system is as follows.

| | |
|---|---|
| Commuter vehicle: | Electric Vehicle, Plug-in Hybrid EV |
| Commute: | 40 miles per day (roundtrip) |
| Example car: | Toyota Prius: |
| Electrical Energy consumption: | 5 miles per kWh |
| Resulting energy use per day: | 8 KWh |

Requirements for a solar carport to provide the energy used for the daily commute:

| | |
|---|---|
| Efficiency of low cost thin film | 10% |
| solar panel: | |
| Area of typical parking space: | 20 m² [200 sq ft] |
| Solar panel power output per | 2 kW [20 m² × 0.1 × 1000 W/m²] |
| parking space: | |
| Required hours to achieve full | 4 hours @1000 W/m² |
| charge: | 4 hr × 2 kW = 8 kWh |

The actual energy harvest will be less than 1000 W/m², which is the maximum value at noontime in the summer in California. Location of the array, time of year and other factors will reduce the energy yield. Under California conditions 6-7 hours are practically needed to collect the energy amount of 8 kWh. The foregoing scenario advantageously would enable an EV to be charged fully during working hours, while being decoupled from the grid during peak demand times.

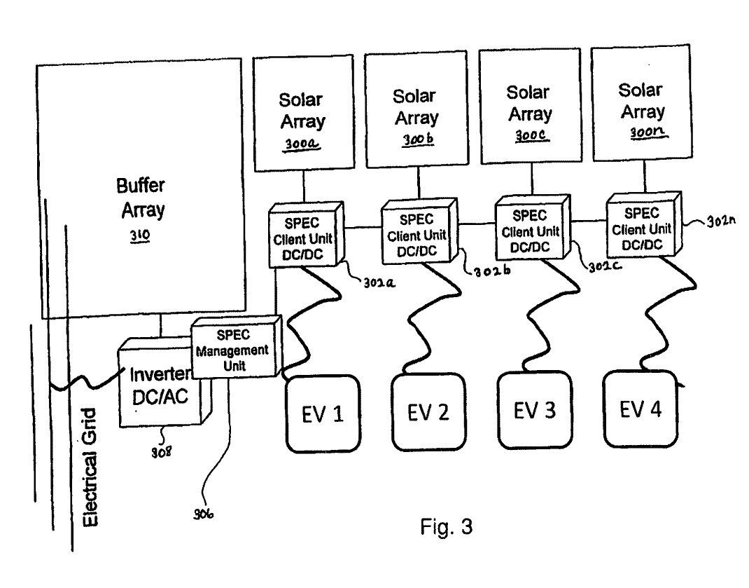

FIG. 3 provides an overview of the principle of operation of a grid independent solar powered EV charging system in accordance with an aspect of the invention. A plurality of solar arrays 300a, 300b, 300c, . . . 300n are each coupled directly to a corresponding solar powered electric charging (“SPEC”) client unit 302. Each SPEC client unit further comprises a DC/DC converter 302a, 302b, 302c, . . . 302n for directly charging a corresponding EV 304 connected to a client unit.

The design of the grid independent charging station advantageously minimizes transport of energy over distances with resulting resistance losses, and instead couples the solar energy directly to the EVs parked in or underneath a parking lot solar array. This maximizes the amount of solar energy available that charges EVs directly. The system is targeted for daily commuter EVs traveling from home to office. In most cases the commuter vehicle sits at the parking lot directly coupled to a solar array during the whole day when the maximum amount of sunlight is available.

The client units 302 are electrically coupled to each other and to a respective solar array 300 such that available solar power can be shared across all client units. Each client unit 302 is also communicatively linked to a management unit 306. Each client unit is provided with a standard input interface that allows a user to enter his/her charge requirements (charging speed, time) and other data as required such as battery capacity. Client units 302 communicate the respective user input charging criteria to the management unit 306, which is provided with standard circuitry for optimizing the power flow to the individual clients accordingly. Thus, commuters having a projected short stay with high charging need could receive preferential charging.

Management unit 306 manages the battery charging of the commuter EV (can be in AC or DC) and manages the available power output of the local PV array 300 (typically provided on top of a parking lot), including maximum power point tracking (MPPT). In cases of AC power distribution, DC/AC functionality is also managed by the management unit 306.

The management unit is provided with standard interactive circuitry such as a charge controller with adaptive feedback circuitry that can query each client unit and assess the EV battery depletion and/or charging needs of each EV battery connected to a respective client unit. The management unit's adaptive feedback circuitry virtualizes all connected EV batteries as a storage unit and substantially maintains the overall equilibrium of the charging system The management unit, in accordance with standard charge control techniques that are well known, equalizes the overall charging supply rate, such that newly added EV batteries can be charged as more EVS are parked at the charging station and added to the system. And, the management unit sends control signals to respective client units to selectively decouple or lessen the rate of charge to EV batteries as they become fully charged.

Alternatively, in times of high demand, each EV battery can be selectively charged to a pre programmed level sufficient to meet the expected drive home in accordance with a commuter's preprogrammed input to each client unit 302.

It will be appreciated that power distribution may be either in DC or AC. Final assessment of the advantages of either configuration will be established with practical experience. First pilot parking stations may use 110V AC for distribution, because currently all EVs are equipped with 110V charging plugs. However, this still can be accomplished directly with a grid independent charging system, and with the EV batteries themselves acting as the overall storage side of the solar array.

In this regard, referring to FIG. 3, solar buffer array 310, is configured to provide a decentralized power source. This power source provided by the buffer array is optional. It improves the overall independence from the grid, but is not required for the functionality of the system. A typical configuration would be a solar array on the rooftop of the office building preferably in proximity of the parking lot. Other decentralized renewable energy sources are also possible.

A typical array size for parking lot solar array based charging station in accordance with an aspect of the invention comprises 20 m² [200 sqft], with a Watt peak power rating of 2-2.5 kW. Such an EV charging station advantageously can be feasible in an urban downtown arrangement. The equivalent solar array easily can be placed on the roof of a building with simple power distribution to EVs parked in an underground parking garage.

Referring again to FIG. 3, PV inverter 308 comprises an off-the-shelf inverter that operates in a well-known manner. In future contemplated developments specialized inverters or inverters integrated with the management unit 306 may be provided in order to compensate for the higher fluctuation of the excess power that is generated by the EV charging system. Such excess power would be fed back into the utility grid. On weekdays, almost no power is expected to be fed back into the grid. However, on weekends almost all power would be fed back into the utility grid.

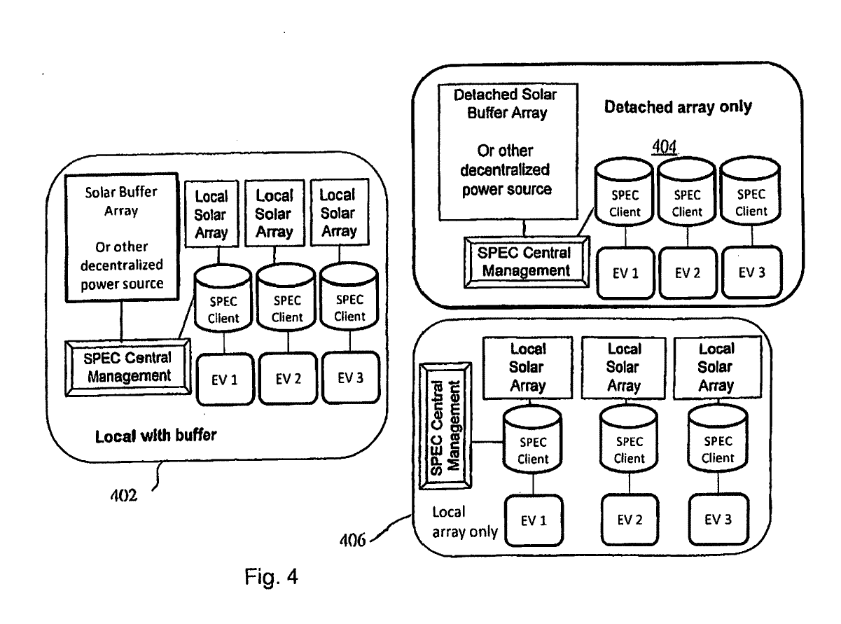

FIG. 4 shows variations of the EV charging system described with reference to FIG. 3. In a first variation 402 a local array with a buffer is shown. The buffer array is provided on a detached location, e.g. roof on adjacent office building. In a second variation 404, charging capability is provided for underground parking with a solar array on roof of building. In this case, the capability of the charging system client can be reduced to handle communication and charge control only; no interaction with a local power source is needed. In cases with existing solar carports an efficient way to upgrade a system, is shown at 406 in which the carport array acts as the buffer. Sufficient power is provided at a local array (such as solar carport) to cover most charge requirements, any additional backup has to come from the grid.

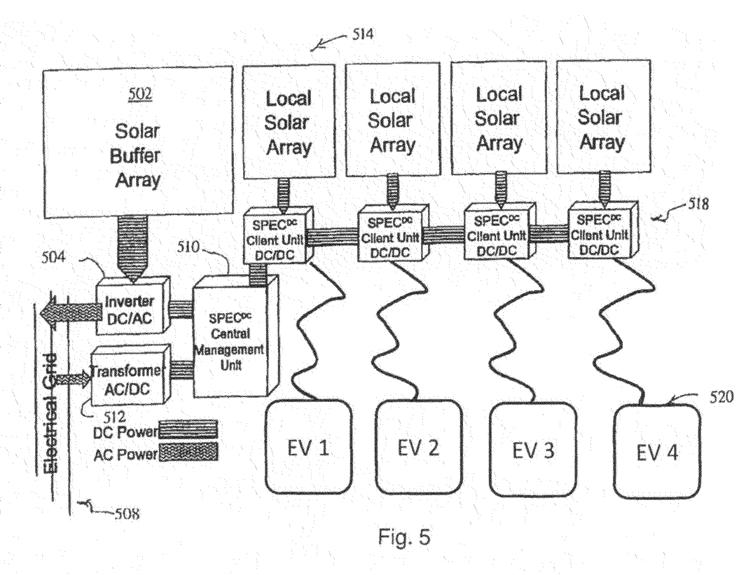

FIG. 5 shows an alternate version of DC power distribution for an EV charging system. In this case, a solar buffer array 502 provides electric power in a well-known manner to a DC/AC inverter 504. AC/DC inverter 504 has an output lead connected to the electrical grid 508 and an input lead coupled with central management unit 510. An AC/DC transformer 512 takes power from electrical grid 508 and provides input power to central management unit 510 in a well-known manner. A plurality of local solar arrays 514 each have an output coupled for providing DC power to a first input of a corresponding plurality of solar powered electric charging (SPEC) units 518. Each SPEC unit 518 is selectively coupled with an EV 520. All SPEC units 518 are connected with central management unit 510 and with appropriate input/output leads for sharing power among the various SPEC units. When an excess of power is developed from local solar arrays 514, central management unit 510 sends this over an output lead to inverter 504 and back into the electrical grid. Central management unit 510 also has an input lead for receiving power from AC/DC transformer 512, and provides that power over an output lead to each respective SPEC unit 518. CMU 510 is provided with means for monitoring respective battery charging needs associated with each SPEC unit 518, such that power is provided to each SPEC unit in accordance with the charging needs of the EV 520 connected thereto.

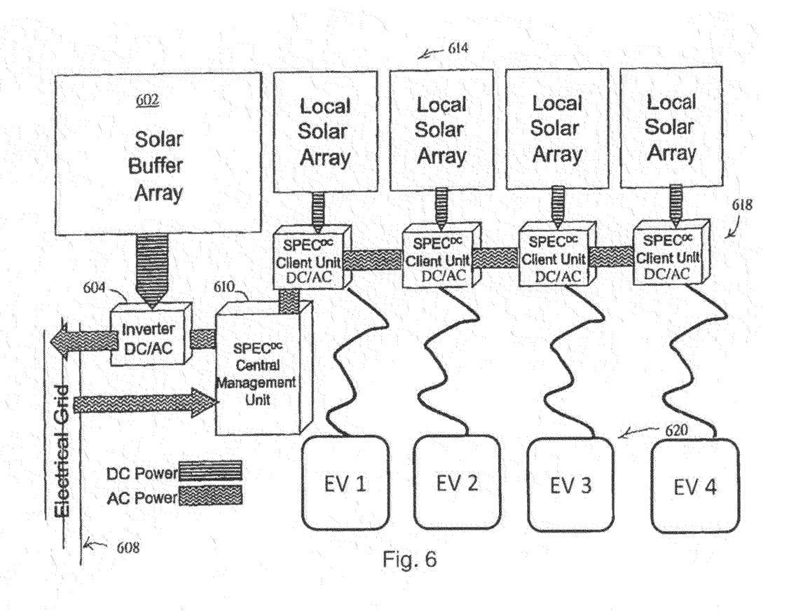

FIG. 6 shows an alternate embodiment with AC power distribution for an EV charging system. In this case, a solar buffer array 602 provides electric power in a well-known manner to a DC/AC inverter 604. AC/DC inverter 604 has an output for providing AC power to the electrical grid 608 and an input lead coupled with central management unit 610. Central management unit 610 is provided with a first input lead coupled with the electric grid 608 for receiving AC power. A plurality of local solar arrays 614 each have an output coupled for providing DC power to a first input of a corresponding plurality of solar powered electric charging (SPEC) units 618. Each SPEC unit 618 is selectively coupled with an EV 620. All SPEC units 618 are connected with central management unit 610 and with appropriate input/output leads for sharing power among the various SPEC units. When an excess of power is developed from local solar arrays 614, central management unit 610 sends this over an output lead to inverter 604 and back into the electrical grid. Central management unit 610 is provided with means for monitoring respective battery charging needs associated with each SPEC unit 618, such that power is provided to each SPEC unit in accordance with the charging needs of the EV 620 connected thereto. Note that in this case SPEC client units include DC/AC converters for charging the EVs 620.

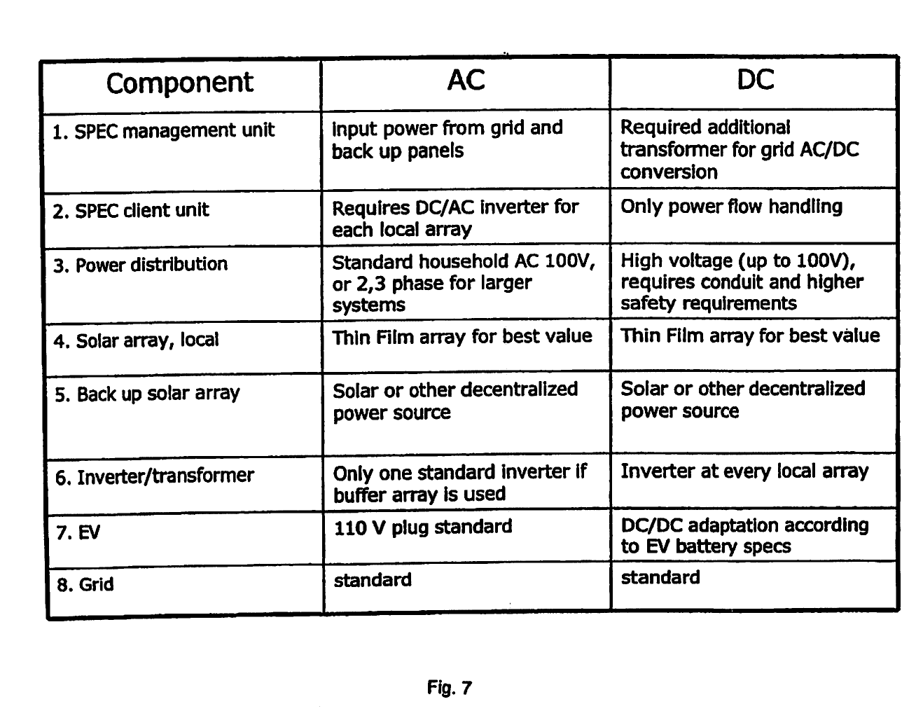

FIG. 7 is a table showing a comparison of features for the DC and AC power distribution systems of FIGS. 5 and 6, respectively.

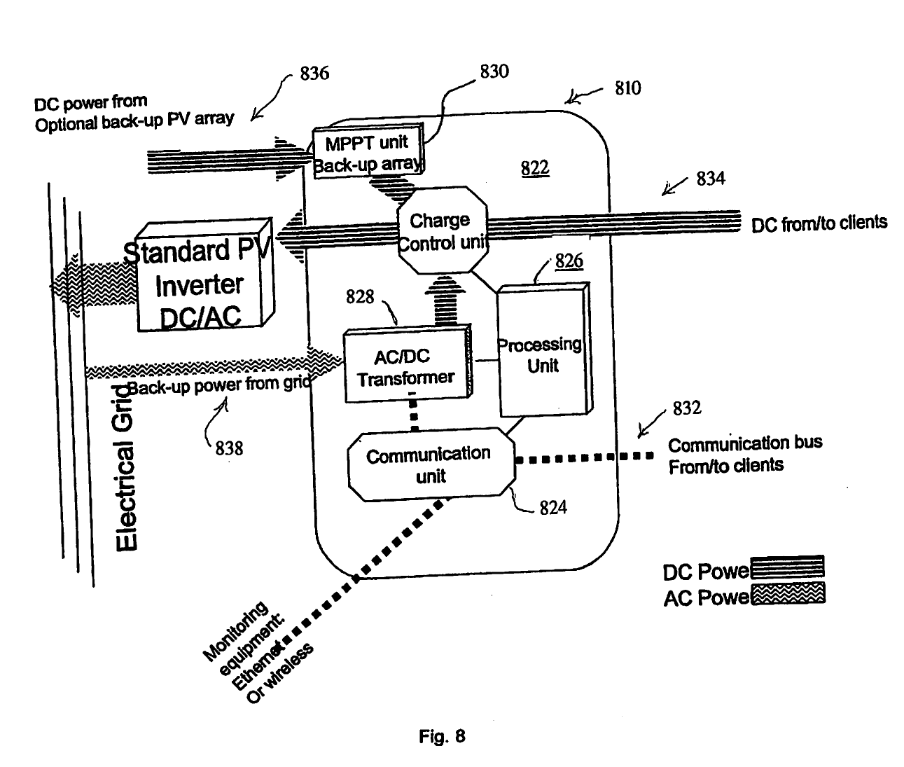

FIG. 8 shows the functionality of the central management unit 810 for a DC based EV charging system as shown in FIG. 5. A charge control unit 822 manages and adjusts the power flow from a plurality of connected SPEC client units a shown in FIG. 5 to keep power consumption and supply in equilibrium. A communication unit 824 is electrically or wirelessly coupled through a processing unit 826 to the charge control unit 822. The communication unit 824 has a wireless or direct connection with an AC/DC transformer 828 that receives backup power from the grid. The communication unit 824 comprises industrial grade communication for wired or wireless data exchange, and receives status and request data from clients, provides data to processing unit and transmits sets of monitoring data out of the system in accordance with standard data logging technology.

AC/DC transformer 828 is directly connected to the processing unit 826. In case of excess demand from the clients, the processing unit instructs the transformer 828 to deliver the required power.

The MPPT unit 830 optimizes the DC power from the buffer array that is used for backup. The charge control unit 822 handles the power flow from buffer array, local arrays and grid as instructed by the processing unit.

The communication flow is generally as follows. Status data from EV clients is provided over a communication bus 832 either wirelessly or directly to communication unit. DC feedback from the clients is also provided to the charge control unit for adaptive feedback monitoring and load balancing as described with reference to FIG. 3.

The power flow in the DC based EV charging system is as follows. The charge control unit 822 provides the required power to the clients using a DC distribution grid 834. The charge control unit 822 receives its instructions from the processing unit. The power sources are the buffer array 836, any excess power that is provided by the sum of all available local arrays and thirdly as a backup from the utility grid shown at 838.

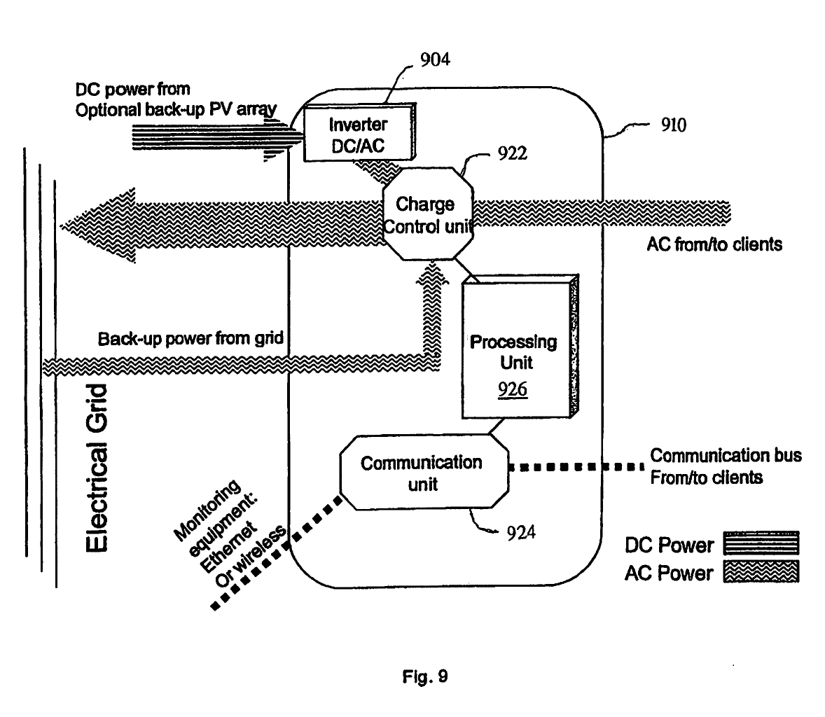

FIG. 9 shows an implementation of a central management unit 910 for AC charging such as in FIG. 6. An AC/DC transformer is not required. The DC/AC inverter 904 for the solar buffer array can be a standard PV inverter. There are no fluctuations as would happen in the DC system. Input and output in AC to the charge control unit 922 is as follows: excess power from the local solar array or back up power to clients can be provided back to the grid.

AC power is provided from a buffer array (not shown for clarity) and is provided to Client EVs in a well-known manner. AC power from the grid can provide backup to the charge control unit 922 if needed. Charge control unit 922 is provided with appropriate connections to SPEC clients as previously described with reference to FIG. 6. DC power from an optional backup array is provided to an inverter (DC/AC converter 904) and to the charge control unit 922. Additional backup power from the grid may be provided directly to the charge control unit and then on to the client SPEC units. The client units are communicatively coupled to the communication unit, processing unit, and charge control unit respectively as described with reference to FIG. 3.

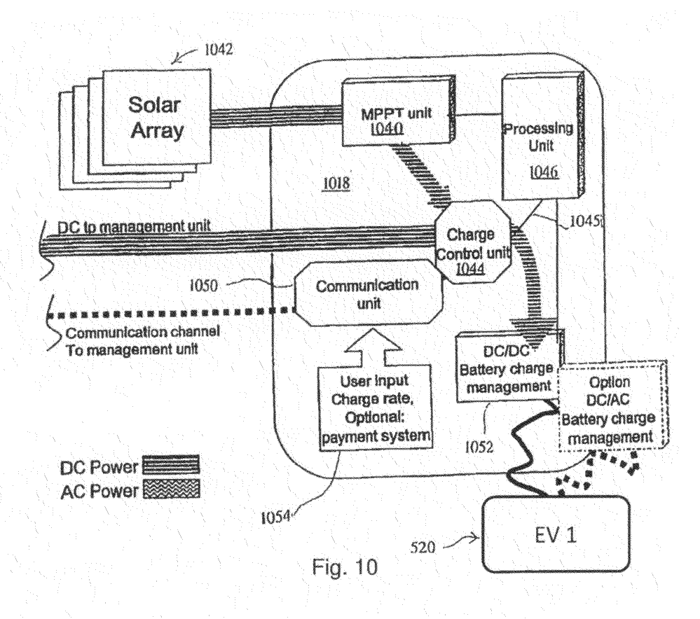

Details of a SPEC client unit 1018 for a DC based EV charging system (such as in FIG. 5) are shown in FIG. 10. Client unit 1018 is provided in a standard weatherproof industrial housing for outdoor use. The main functional components of the unit 1018 comprise the following: a standard maximum power point tracking (MPPT) unit 1040 connected for receiving DC output with a solar array 1042 and having an output with a charge control unit 1044 for maximizing DC power input and controlling DC power to the battery charge management system in a known manner.

The charge control unit 1044 establishes a target charge rate as determined by the user. The charge control unit receives instructions from the processing unit 1046 over wired or wireless communication link 1048. A communication unit 1050 provides user input such as, for example, charge rate, pre-payment for specific charge time and/or rate, distance to be traveled, battery capacity and so forth. The charge control unit 1044 then channels power flow to the battery charge management unit 1052 in accordance with input parameters received by the communication unit. That is, the communication unit receives user interface data and sends it to the management unit, which governs communication among client and charging components. The battery charge management unit 1052 includes adaptive feedback communicatively coupled to the charge control unit 1044 for decoupling an EV when its battery is fully charged or otherwise charged in accordance with parameters sent to the communication unit.

Referring to FIG. 10, a user interface comprises a communication means 1054 for a user to select input parameters determining the amount of charge needed; for example a charge rate equivalent to a full charge in 3-6 hours, or quick charge in 10 minutes. The user interface can be coupled with a payment function. Respective data are forwarded from the communication unit in the client to the central management unit. Since DC is used, no inverter is necessary; the MPPT unit maximizes power from the local solar array.

A battery charge unit/interface is also provided, based on the battery charge characteristics, the appropriate charge management (e.g., well known battery charging technology) is applied to achieve proper charging of each EV client. It would be convenient to use DC directly to the DC battery. However, most EVs are already equipped with an AC charger. A communication channel is provided from each client unit to a central management unit in accordance with techniques that are well known, as previously described.

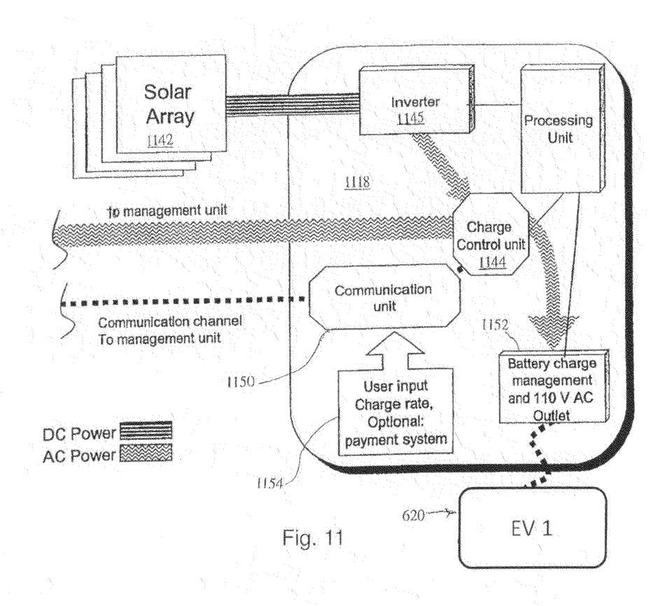

FIG. 11 shows details of a client unit 1118 in an AC based EV charging system as in FIG. 6. The charge control unit 1144 receives AC input power from the grid and/or from a DC/AC converter 1145 from the solar array 1142. The inverter/converter 1145 required for DC/AC transformation is functionally identical to standard PV inverters. The client unit 1118 also could also be built as an add-on to an existing inverter architecture. A battery charge management unit 1152 is provided for coupling charge to the EV client 620 in a known manner. In principle, existing EV chargers could be integrated into the system, such that their AC input would be supplied by the sub-grid instead of the utility grid. A communication unit 1150 is provided for receiving user input such as, for example, charge rate, pre-payment for specific charge time and/or rate, distance to be traveled, battery capacity as described with respect to FIG. 10. The charge control unit 1144 then channels power flow to the battery charge management unit 1152 in accordance with input parameters received by the communication unit.

Depending on the size of the system, AC will be distributed to EV clients in conventional ranges, single phase, two and three-phase. The decision as to what system size and respective power phases will be used depends on the overall system economics. It will be appreciated that practically unlimited scaling is possible, because any system increase can be achieved by adding a new sub-grid. The more sub-grids that are connected, the easier it will be to balance the overall load.

While the invention has been described in connection with what are presently considered to be the most practical and preferred embodiments, it is to be understood that the invention is not limited to the disclosed embodiments and alternatives as set forth above, but on the contrary is intended to cover various modifications and equivalent arrangements.

Therefore, persons of ordinary skill in this field are to understand that all such equivalent arrangements and modifications are to be included within the scope of the following claims.

I claim:

1. A grid independent solar powered charging system for electric vehicles (EVs) comprising:
one or more solar arrays, each providing an output voltage;
a buffer circuit for combining the output voltage of the solar arrays;
a charge controller connected to the buffer circuit for providing a charging voltage;
a plurality of interactive, electric charging units electrically coupled to each other for sharing the charging voltage from the charge controller, each charging unit having a first communication link selectively coupled to a respective EV for receiving input data including EV battery storage parameters and charging need, and a second communication link coupled to the charge controller for communicating input data and state of charge, and having an output lead for selectively charging an EV connected thereto.

2. A grid independent solar powered charging system for electric vehicles as in claim 1, wherein the charge controller further comprises a control unit responsive to EV input data and charge state for distributing electric power to the charging units such that available electric power from the buffer circuit is stored across all EVs and provided to each EV according to its respective input data.

3. A grid independent solar powered charging system for electric vehicles (EVs) having a battery characterized by capacity to hold an electric charge comprising:
one or more solar arrays, each providing an output voltage;
a buffer for combining the output voltage of the solar arrays;
a plurality of client charging circuits, each for charging the battery of a respective EV connected thereto, and being coupled electrically to each other and for receiving the voltage from the buffer such that available solar power from the buffer is shared across all client units;
a charge controller communicatively connected to each respective client charging circuit for controlling charge to each connected each EV according to its battery capacity.

4. A grid independent solar powered charging system for electric vehicles as in claim 3, wherein the cumulative battery capacity of all EVs connected to the client units comprises a means for storing the available power from the solar arrays.
